(19) United States
(12) Patent Application Publication
(10) Pub. No.: US 2017/0178238 A1
(43) Pub. Date: Jun. 22, 2017

(54) SHAREHOLDER COURTESY SYSTEM

(71) Applicant: NOMURA RESEARCH INSTITUTE, LTD., Tokyo (JP)

(72) Inventor: Yasunori HOKAZONO, Tokyo (JP)

(73) Assignee: NOMURA RESEARCH INSTITUTE, LTD., Tokyo (JP)

(21) Appl. No.: 15/447,745

(22) Filed: Mar. 2, 2017

Related U.S. Application Data
(63) Continuation of application No. PCT/JP2014/084627, filed on Dec. 26, 2014.

(51) Int. Cl. G06Q 40/04; G06Q 40/06

(52) U.S. Cl. CPC G06Q 40/04; G06Q 40/06

(57) ABSTRACT

In a shareholder courtesy system, a listed company enables a shareholder to receive shareholder courtesy services from a specific servicer regardless of a record date. The system includes: a courtesy information db for holding combinations of listed companies and servicers, contents of the shareholder courtesy services pertaining to the respective combinations, and a condition of a number of held shares. A held-shares information acquisition unit receives a request transmitted from the servicers when the shareholder purchases products and the like from the servicers. The request confirms presence or absence of the shareholder courtesy services that can be provided to the shareholder. A courtesy decision unit decides the shareholder courtesy services that satisfy conditions among the shareholder courtesy services that the servicers can offer based on information on the number of held shares for each listed company of the shareholder, and for responding to the servicers.

### TECHNICAL FIELD

The present invention relates to a technology for supporting IR (Investor Relations) activities of enterprises, and more particularly to a technology that is effectively applied to a shareholder courtesy system providing courtesy services to shareholders.

### BACKGROUND ART

In Japanese listed companies, many of companies have established a so-called shareholder special-benefit plan for providing specific courtesy to the shareholders holding shares of each company on a predetermined record date(s) one or two times a year as one means of IR, which is mainly useful to increase individual shareholders. In many cases, general shareholder courtesy provides the shareholders with products and services themselves sold by the targeted company, or with coupons and the like usable for these purchases. On the other hand, in some cases, companies not dealing with products or services for individual consumers provide products and the like that they do not deal directly with, such as local specialty products, or general-purpose premium tickets and gift certificates.

As a technology related to the shareholder courtesy, for example, Japanese Patent Application Laid-open No. 2005-11022 (Patent Document 1) describes a shareholder-courtesy point management system that stores shareholder-courtesy points in a common shareholder-courtesy point card issued from a joint enterprise joined by a plurality of different industry business units, and enables the shareholders to use the shareholder-courtesy point card as electronic money at a fair(s) hosted by the joint venture or a member store(s) of companies joining the joint enterprise.

In addition, Japanese Patent Application Laid-open No. 2005-250715 (Patent Document 2) describes a shareholder-courtesy service system that expands contents of shareholder courtesy services into products of partnered companies, and that does not only diversify contents of courtesy services to shareholders but also reduce burdens of courtesy-service providing companies with their uniqueness maintained.

In addition, Japanese Patent Application Laid-open No. 2005-267402 (Patent Document 3) describes a shareholder courtesy system that determines whether or not buying-and-selling-of-shares history of share-issuing companies by customers matches usable requirements of shareholder courtesy set by the share-issuing companies, and that allows that customers to use the shareholder courtesy even before a vesting date (s) if the history matches them.

### RELATED ART DOCUMENTS

### Patent Documents

Patent Document 1: Japanese Patent Application Laid-Open No. 2005-11022

Patent Document 2: Japanese Patent Application Laid-Open No. 2005-250715

Patent Document 3: Japanese Patent Application Laid-Open No.

2005-267402

### SUMMARY OF THE INVENTION

### Problems to be Solved by the Invention

According to the conventional technologies, the listed companies can give preferential treatment by providing the products and services to the shareholders through other companies other than themselves, can also give the preferential treatment without limiting to the shareholders on the record date, and can improve a degree of freedom and flexibility of the shareholder courtesy.

However, in a case of a cooperative scheme for plural participating companies like the conventional technology, since a uniform scheme is kept among the participating companies, an appeal effect on the shareholders may be diluted for the listed companies issuing the shares subject to the shareholder courtesy. In addition, the listed companies, and service providers (hereinafter sometimes referred to as “servicers”) of shops and the like giving the preferential treatment by providing the products, services, and the like to the shareholders on behalf of the listed companies also have, among them, risks of combinations with counterparts not desired for each other.

Thus, an object of the present invention is to provide a shareholder courtesy system in which the listed company allows the shareholders to receive the shareholder courtesy services from a specific servicer regardless of the record date.

The above and other objects and novel characteristics of the present invention will be apparent from the description of the present specification and the accompanying drawings.

### Means for Solving the Problems

The following is a brief description of an outline of the typical invention disclosed in the present application.

A shareholder courtesy system according to a representative embodiment of the present invention is a shareholder courtesy system for supporting provision for shareholder courtesy services to a shareholder of listed companies, and has the following features.

That is, the shareholder courtesy system includes a courtesy-information holding unit that holds: combinations of the listed companies and servicers for providing the shareholder courtesy services instead of the listed companies; contents of the shareholder courtesy services pertaining to the respective combinations; and a condition of a number of held shares capable of receiving the shareholder courtesy services.

Further, the shareholder courtesy system includes a held-shares information acquisition unit for: receiving a request for confirming presence or absence of the shareholder courtesy services capable of being provided to the shareholder, the request being transmitted from the servicers when the shareholder purchases a product or a service in the servicers; acquiring the shareholder courtesy services capable of being provided by the servicers from the courtesy-information holding unit; and inquiring of a predetermined share-information management entity, the number of held shares of the shareholder about the listed companies corresponding to the acquired respective shareholder courtesy services, and a courtesy decision unit for deciding the shareholder courtesy services in which the shareholder satisfies the condition pertaining to the number of held shares among the shareholder courtesy services capable of being provided by the servicers based on information on the number of held shares of the shareholder for each of the listed companies, the information being acquired from the share-information management entity, and for responding to the servicers.

### Effects of the Invention

The effects obtained by typical embodiments of the invention disclosed in the present application will be briefly described below.

That is, according to a representative embodiment of the present invention, the listed company can allow the shareholders to receive the shareholder courtesy services from the specific servicer regardless of the record date.

### BRIEF DESCRIPTIONS OF THE DRAWINGS

FIG. 1 is a diagram illustrating an outline of a configuration example of a shareholder courtesy system that is an embodiment of the present invention.

FIG. 2 is a diagram illustrating an example of a processing flow until a shareholder receives a shareholder courtesy service in the embodiment of the present invention.

### DETAILED DESCRIPTION OF PREFERRED EMBODIMENTS

Hereinafter, embodiments of the present invention will be described in detail with reference to the accompanying drawings.

Note that components having the same function are denoted by the same reference characters throughout the drawings for describing the embodiments, and the repetitive description thereof will be omitted.

### System Configuration

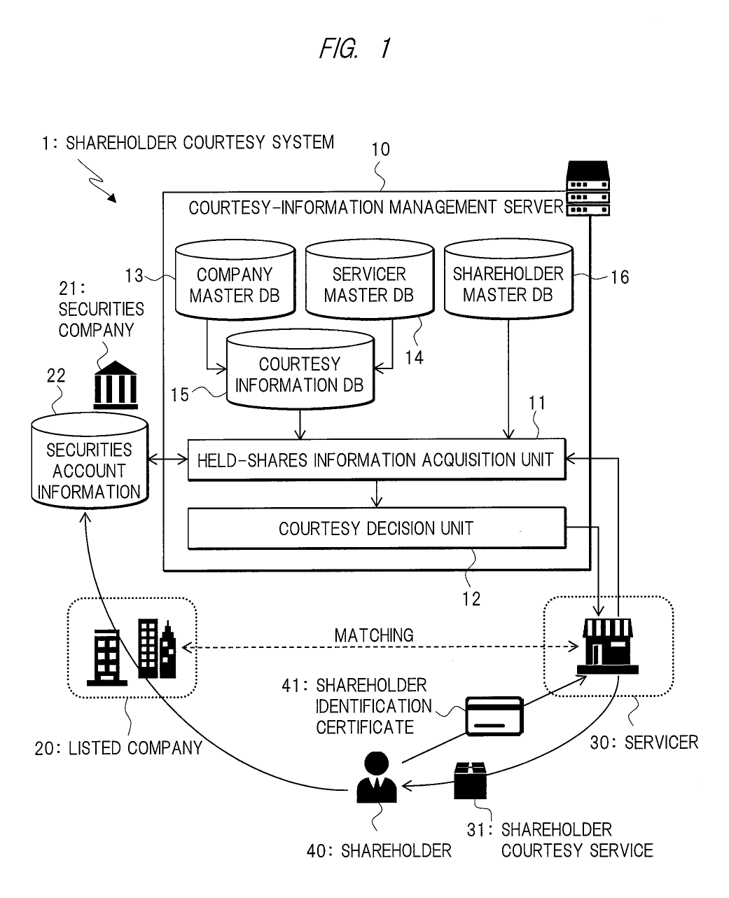

FIG. 1 is a diagram illustrating an outline of a configuration example of a shareholder courtesy system that is an embodiment of the present invention. A shareholder courtesy system 1 is a system that supports shareholder courtesy provided to a shareholder 40 by listed companies 20 and, specifically, a system that enables individual partnered servicers 30 to indirectly provide shareholder courtesy services 31 to the shareholder 40 when the listed companies 20 do not deal with products and the like which can be directly provided to the shareholder 40 as courtesy services.

Information on the shares of the listed companies 20 owned by the shareholder 40 is managed in a database of securities account information 22 and the like inside a back office system (not shown) of a securities company 21. The shareholder 40 receives a cash card and the like, which are associated with information about his/her own account in the securities account information 22 and issued from the securities company 21, and presents this as shareholder identification certificate 41 so as to allow the shareholder 40 to be identified when receiving the shareholder courtesy services 31 from the servicers 30. It should be noted that the shareholder identification certificate 41 is not limited to the cash card and the like issued by the securities company 21 as long as the shareholder 40 can be identified and, for example, may be another card such as a credit card, and be a member card, a point card, or the like issued by the servicer 30.

Incidentally, the present embodiment exemplifies a case where the shareholder 40 purchases the shares of the listed companies 20 through the partnered securities company 21, and the information on the shares of the listed companies 20 owned by the shareholder 40 is assumed to be acquired from the securities company 21. But, the present embodiment is not limited to this as long as the shareholder 40 is an entity (a share-information management entity) having a mechanism for managing the information on the shares owned by him/her. For example, it may be configured to acquire information pertaining to the shares held by the shareholder 40 from a trust bank managing shareholder lists of the listed companies 20 (in this case, the shareholder lists managed by the trust bank are desirably reflected about the information on the shareholder 40 and the number of held shares in conjunction with actual buying and selling as much as possible).

The shareholder courtesy system 1 includes a courtesy-information management server 10 as a server system including, for example, a server device and a virtual server built on a cloud-computing environment. The courtesy-information management server 10 can communicate with the back office system and the like (not shown) of the securities company 21 through a network such as the Internet (not shown). In addition, the courtesy-information management server 10 can communicate with an information processing apparatus such as a POS (Point Of Sale) cash-register terminal (not shown) installed in each servicer 30, and a Web system and the like for online sales.

The courtesy-information management server 10 includes each unit such as a held-shares information acquisition unit 11 and a courtesy decision unit 12 which are implemented as software running on middleware, for example, on an OS (Operating System) and a DBMS (Database Management System), or a Web server program that is not illustrated. In addition, the courtesy-information management server 10 includes each table of a company master database (DB) 13, a servicer master DB 14, a courtesy information DB 15, a shareholder master DB 16, and the like which are implemented as databases.

The held-shares information acquisition unit 11 has a function of: receiving a courtesy confirmation request pertaining to the shareholder 40 and transmitted from the servicers 30 through the POS cash-register terminal, the Web system, and the like (not shown); and acquiring the number of shares of the listed companies 20 owned by the shareholder 40 from a system of the securities company 21 based on contents of the request.

The courtesy confirmation request transmitted from the servicers 30 includes: information such as an ID and a name for identifying the servicer 30; and a securities account number (that is, identification information in the share-information management entity) and the like of the securities company 21 obtained from the shareholder identification certificate 41 that the shareholder 40 offers to the servicers 30. It should be noted that the shareholder 40 can beforehand register the information on the securities account number in association with information on one or more point cards and the like in the shareholder master DB 16. This allows the held-shares information acquisition unit 11 to acquire the information on the securities account number by referring to the shareholder master DB 16 from the information on the point card included in the courtesy confirmation request even if the shareholder identification certificate 41 presented by the shareholder 40 in the servicer 30 is, for example, based on a point card and the like issued by the servicer 30.

Furthermore, the held-shares information acquisition unit 11 acquires a list(s) of the shareholder courtesy services 31 that the servicers 30 can provide, and acquires a list(s) including the information on the listed companies 20 serving as each implementing source of the courtesy with reference to the courtesy information DB 15 in order to confirm whether the shareholder 40 holds the shares of the listed companies 20 capable of receiving the shareholder courtesy services 31 in the servicers 30. Incidentally, registered in the courtesy information DB 15 are contents of the shareholder courtesy services 31 and information on conditions such as the required number of shares for each combination with the listed companies 20 registered in the company master DB 13 and the servicers 30 registered in the servicer master DB 14, that is, for each partner relationship pertaining to the shareholder courtesy services 31.

Then, the held-shares information acquisition unit 11 has a function of inquiring the number of shares held by the shareholder 40 pertaining to each listed company 20 included in a list of the listed companies 20 acquired from the courtesy information DB 15 of the system in the partnered securities company 21. Zero is returned if the shares of the targeted listed company 20 are not held. It should be noted that the securities company 21 may have a dedicated interface such as a gateway for accepting inquiries from the courtesy-information management server 10. In addition, the partnered securities company 21 maybe fixed as a partner destination of the shareholder courtesy system 1 itself, or may be different for each targeted listed company 20. In this case, the information on the partner-destination securities company 21 is registered in the company master DB 13 as information unique to each listed company 20.

The courtesy decision unit 12 has a function of deciding whether or not the shareholder courtesy services 31 can be received in the targeted servicer 30 based on the information on the number of shares held by the shareholder 40 for each listed company 20 and acquired from the held-shares information acquisition unit 11. That is, the courtesy decision unit 12 identifies some services satisfying the conditions of the number of held shares required for the corresponding listed company 20 among the shareholder courtesy services 31 provided by the servicers 30 and registered in the courtesy information DB 15. If there is at least one corresponding shareholder courtesy service 31, the courtesy decision unit 12 responds to the servicers 30 with the information on these shareholder courtesy services 31.

### Processing Flow

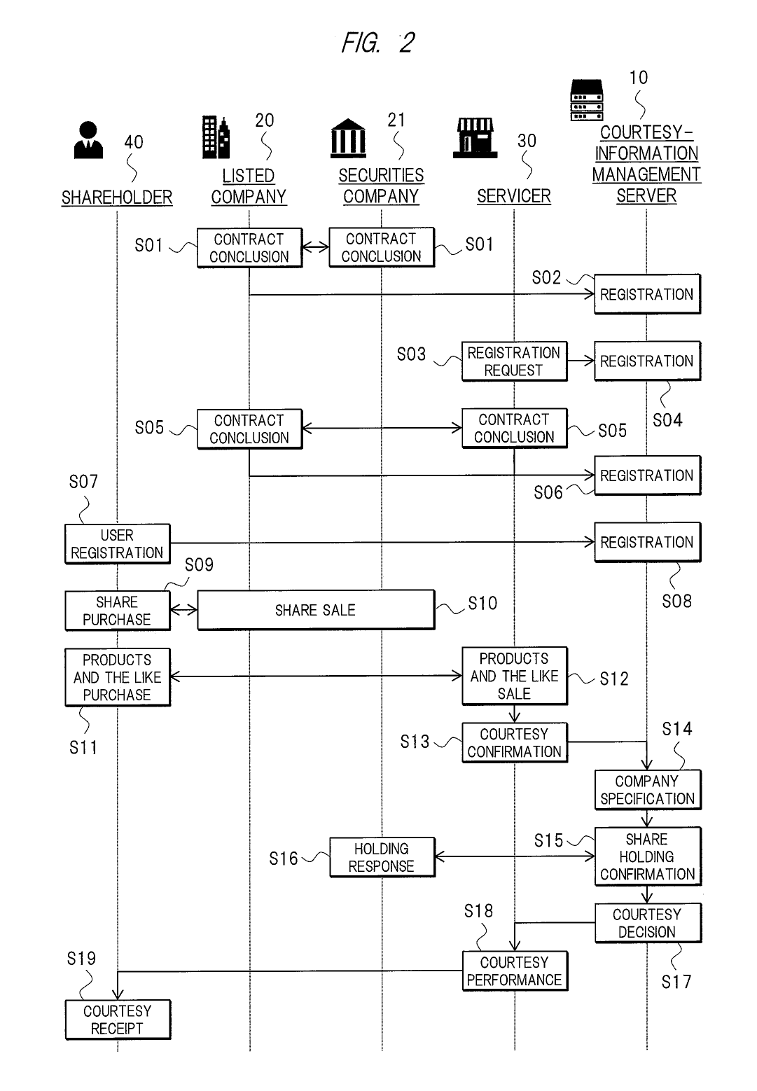

FIG. 2 is a diagram illustrating an example of a processing flow until the shareholder 40 receives the shareholder courtesy services 31 in the present embodiment. The listed companies 20 participating in a scheme achieved by the shareholder courtesy system 1 according to the present embodiment decide in advance the securities company 21 that can handle their own shares as an object of the shareholder courtesy services 31, concludes a contract for forming a partner in the scheme (S01), and registers its information in the courtesy-information management server 10 (S02).

In the present embodiment, this information is registered in the company master DB 13. Incidentally, as described above, a fixed securities company 21 may be provided as a partner destination of the shareholder courtesy system 1 itself rather than each listed company 20 individually registering the securities company 21. In this case, contract-concluding processes in step S01 are no longer necessary, and the listed company 20 is only needed to register its own information in the courtesy-information management server 10 in step S02.

In addition, the servicers 30 to participate in the scheme also register their own information in the courtesy-information management server 10 in advance (S03 and S04). In the present embodiment, this information is registered in the servicer master DB 14.

Then, when the listed company 20 desiring to provide the shareholder courtesy services 31 through the servicers 30 concludes a contract for partnering in the scheme with the servicers 30 desiring to spread their own products and the like to customers and to acquire customers (S05), the information is registered in the courtesy-information management server 10 (S06). The registration contents also include information such as the contents of the shareholder courtesy services 31 provided by the listed companies 20 through the servicers 30, the conditions of the number of held shares, and the like. These pieces of information are registered in the courtesy information DB 15. The registration may be performed by the listed companies 20 or by the servicers 30. It should be noted that the contents of the shareholder courtesy services 31 can be set variously, such as discounts on products and the like purchased at the servicers 30, free offerings of products and services sold and provided by the servicers 30, and the like, and the listed companies 20 bear these funds in principle.

On the other hand, the shareholder 40 (which is, strictly speaking, an “investor” rather than a “shareholder” until purchasing the shares of the listed companies 20, but is treated as a “shareholder” in the present embodiment) who will receive the shareholder courtesy services 31 in this scheme performs user registration on the courtesy-information management server 10 in advance (S07 and S08). Here, the shareholder 40 mainly registers information of a medium such as a card used as the shareholder identification certificate 41 in a store(s) or the like of the servicer 30. As described above, the shareholder 40 can use, as the shareholder identification certificate 41, a membership card and a point card issued by the servicers 30 and the like, further, a certificate and the like capable of identifying an individual such as a driver's license. These pieces of identification information, and the information associated with the securities account that the shareholder 40 holds in the securities company 21 are registered in the shareholder master DB 16 in advance.

The shareholder 40 purchases the shares sold in the market by the listed companies 20 through the securities company 21 (S09 and S10). In the securities account information 22 held by the securities company 21, the information on the shares purchased by the shareholder 40 is reflected. Incidentally, a method by which the shareholder 40 purchases the shares is not particularly limited. The shareholder 40 may purchase the shares through over-the-counter sells of the securities company 21, or through online trades.

Incidentally, as described above, the respective processes of: the registration of the listed companies 20 in the courtesy-information management server 10 (steps S01 and S02); the registration of the servicers 30 (steps S03 and S04); the registration of the combination of the listed companies 20 and the servicers 30, and the contents of the shareholder courtesy services 31 (steps S05 and S06); the user registration of the shareholder 40 (steps S07 and S08); and the share purchase by the shareholder 40 (steps S09 and S10) are not limited to a case of execution in an order shown in FIG. 2, and the order of these may be changed.

Thereafter, when the shareholder 40 purchases the products and the services sold at the store and the like of the servicers 30 (S11 and S12), the POS cash-register terminal, the Web system, or the like performs a request for confirming presence or absence of the shareholder courtesy services 31 capable of being provided to the shareholder 40 on the courtesy-information management server in the servicers 30 (S13). As described above, the courtesy-confirmation request includes the information such as the ID and the name for identifying the servicers 30, and the identification information obtained from the shareholder identification certificate 41 presented to the servicers 30 by the shareholder 40.

In the courtesy-information management server 10 receiving the request, the held-shares information acquisition unit 11 refers to the courtesy information DB 15 based on the information identifying the servicers 30 included in the request, and specifies the listed companies 20 capable of providing the shareholder courtesy services 31 through the servicers 30 (S14). Then, the held-shares information acquisition unit: specifies the information on the targeted securities company 21 and its securities account based on the identification information of the shareholder identification certificate 41 included in the request; inquires of the securities company 21 whether or not the shareholder holds the shares of each of the listed companies 20 specified in step S14 in the securities account; and acquires its results (S15 and S16). Incidentally, as described above, when the shareholder 40 previously registers use of the point card or the like as the shareholder identification certificate 41 in the shareholder master DB 16, the information on the securities account associated with the point card can be obtained with reference to this.

Subsequently, the courtesy decision unit 12 determines whether or not the shareholder 40 can receive the shareholder courtesy services 31 in the targeted servicer 30 based on the information on the number of held shares for each listed company 20 of the shareholder 40 acquired from the held-shares information acquisition unit 11 (S17). Here, as described above, among the shareholder courtesy services 31 provided by the servicers 30 and registered in the courtesy information DB 15, those that the shareholder 40 satisfies the conditions of the required number of held shares concerning the corresponding listed company 20 are specified.

In the present embodiment, the courtesy-information management server 10 acquires the number of held shares of the shareholder 40 concerning each listed company 20 from the securities company 21, and the courtesy decision unit 12 of the courtesy-information management server 10 determines whether or not the shareholder courtesy services 31 can be received. However, the present embodiment is not limited to this. In order for the securities company 21 to avoid unnecessarily disclosing information, such as names of the listed companies 20 whose shares the shareholder 40 holds and the number of held shares, to the courtesy-information management server 10, the system of the securities company 21 side may perform the decision as to whether or not the targeted shareholder courtesy service 31 can be provided, and the courtesy-information management server 10 may acquire only the decision results.

In step S15, if there is at least one corresponding shareholder courtesy service 31, the information on these shareholder courtesy services 31 is transmitted to the servicers 30 as a response. If the corresponding shareholder courtesy service 31 is not present, a message that the shareholder courtesy service 31 cannot be received is transmitted as a response.

In the servicer 30, when the information on one or more shareholder courtesy services 31 are answered from the courtesy-information management server 10, these shareholder courtesy services 31 are performed on and provided to the shareholder 40 (S18 and S19). If a plurality of shareholder courtesy services 31 are answered, all of these may be performed and provided in an overlapping manner, or only a predetermined number of shareholder courtesy services 31 may be performed and provided. In the latter case, the shareholder courtesy services 31 to be performed and provided may be selected by the shareholder 40, or may be automatically decided based on a predetermined priority order.

As described above, according to the shareholder courtesy system 1 that is an embodiment of the present invention, even when the listed company 20 does not deal with the products and the like which can be directly provided as the shareholder courtesy services 31 to the shareholder 40, the shareholder courtesy services 31 can be indirectly provided to the shareholder 40 by the individually partnered servicers 30 at any time regardless of the record date in the listed companies 20, and the effective IR activities for investors and the shareholders 40 can be conducted.

In the foregoing, the invention made by the inventor of the present invention has been concretely described based on the embodiments. However, it is needless to say that the present invention is not limited to the foregoing embodiments and various modifications and alterations can be made within the scope of the present invention. For examples, the embodiments above have been described in detail so as to make the present invention easily understood, and the present invention is not always limited to the embodiment having all of the described constituent elements. Also, a part of the configuration of each embodiment may be added, eliminated or replaced with another configuration.

### INDUSTRIAL APPLICABILITY

The present invention is applicable to the shareholder courtesy system for providing the courtesy services to the shareholder.

### REFERENCE SIGNS LIST

1 . . . shareholder courtesy system; 10 . . . courtesy-information management server; 11 . . . held-shares information acquisition unit; 12 . . . courtesy decision unit; 13 . . . company master DB; 14 . . . servicer master DB; 15 . . . courtesy information DB; 16 . . . shareholder master DB; 20 . . . listed company; 21 . . . securities company; 22 . . . securities account information; 30 . . . servicer; 31 . . . shareholder courtesy service; 40 . . . shareholder; and 41 . . . shareholder identification certificate

1. A shareholder courtesy system for supporting provision of shareholder courtesy services for a shareholder of listed companies, the shareholder courtesy system comprising:
a courtesy-information holding unit that holds: combinations of the listed companies and servicers for providing the shareholder courtesy services instead of the listed companies; contents of the shareholder courtesy services pertaining to the respective combinations; and a condition of a number of held shares capable of receiving the shareholder courtesy services;
a held-shares information acquisition unit for: receiving a request for confirming presence or absence of the shareholder courtesy services capable of being provided to the shareholder, the request being transmitted from the servicers when the shareholder purchases a product or a service in the servicers; acquiring the shareholder courtesy services capable of being provided by the servicers from the courtesy-information holding unit; and inquiring, of a predetermined share-information management entity, the number of held shares of the shareholder about the listed companies corresponding to the acquired respective shareholder courtesy services; and
a courtesy decision unit for deciding the shareholder courtesy services in which the shareholder satisfies the condition pertaining to the number of held shares among the shareholder courtesy services capable of being provided by the servicers based on information on the number of held shares of the shareholder for each of the listed companies, the information being acquired from the share-information management entity, and for responding to the servicers.

2. A shareholder courtesy system for supporting provision of shareholder courtesy services for a shareholder of listed companies, the shareholder courtesy system comprising:
a courtesy-information holding unit that holds: combinations of the listed companies and servicers for providing the shareholder courtesy services instead of the listed companies; contents of the shareholder courtesy services pertaining to the respective combinations; and a condition of a number of held shares capable of receiving the shareholder courtesy services;
a held-shares information acquisition unit for: receiving a request for confirming presence or absence of the shareholder courtesy services capable of being provided to the shareholder, the request being transmitted from the servicers when the shareholder purchases a product or a service in the servicers; acquiring the shareholder courtesy services capable of being provided by the servicers from the courtesy-information holding unit; and inquiring, of a predetermined share-information management entity, presence or absence of the shareholder courtesy services in which the shareholder satisfies the condition pertaining to the number of held shares about the listed companies corresponding to the acquired respective shareholder courtesy services; and
a courtesy decision unit for responding to the servicers with information on the shareholder courtesy services satisfying the condition pertaining to the number of held shares, the information being acquired from the share-information management entity.

3. The shareholder courtesy system according to claim 1,
further comprising a shareholder master information holding unit for holding a correspondence between first identification information pertaining to the shareholder in the share-information management entity and second identification information pertaining to a medium capable of identifying the shareholder, the medium being held by the shareholder,
wherein the held-shares information acquisition unit refers to the shareholder-master information holding unit, acquires the corresponding first identification information from the second identification information included in the request transmitted from the servicers, and inquires of the share-information management entity by using the acquired first identification information.

4. The shareholder courtesy system according to claim 2,
further comprising a shareholder master information holding unit for holding a correspondence between first identification information pertaining to the shareholder in the share-information management entity and second identification information pertaining to a medium capable of identifying the shareholder, the medium being held by the shareholder,
wherein the held-shares information acquisition unit refers to the shareholder-master information holding unit, acquires the corresponding first identification information from the second identification information included in the request transmitted from the servicers, and inquires of the share-information management entity by using the acquired first identification information.
